(19) United States
(12) Patent Application Publication
(10) Pub. No.: US 2004/0054512 A1
(43) Pub. Date: Mar. 18, 2004

(54) Method for making simulator program and simulator system using the method

(76) Inventors: Byung-Su Kim, Seoul (KR); In-Young Choi, Daejeon-city (KR); Young-Min Lee, Daejeon-city (KR)

Correspondence Address: Blakely Sokoloff, Taylor & Zafman, 7th Floor, 12400 Wilshire Boulevard, Los Angeles, CA, 90025, US

(21) Appl. No.: 10/451,058

(22) PCT Filed: Dec. 19, 2001
(86) PCT No.: PCT/KR01/02209

(30) Foreign Application Priority Data
Dec. 20, 2000 (KR) 2000/79346
Jun. 13, 2001 (KR) 2001/33164

(51) Int. Cl. G06F 19/00

(52) U.S. Cl. 703/8; 706/10

(57) ABSTRACT

A method for producing a simulator program includes: generating video and audio information from a camera mounted on a vehicle to be simulated; measuring motion data according to a pose change of the camera; processing the motion data and generating motion effect data comprising position and rotary motion information including acceleration and angular velocity for each axis x, y, and z; separating a motion unit from the motion data to generate a motion unit data stream and synchronizing the motion unit data with video/audio data; recognizing and determining a motion unit representing position and rotary motion information for each axis based on the motion unit data stream; and generating a control unit representing position and rotary motion information suitable for a simulator having a fixed degree of freedom and a fixed movement space, based on the motion unit, and producing a control unit shift function and composite control data.

### BACKGROUND OF THE INVENTION

(a) Field of the Invention

The present invention relates to a method for producing a simulator program and a simulator system using the same. More specifically, the present invention relates to a heuristic simulator combined with augmented reality technology based on images of the real world taken by a camera, and an apparatus and method for driving the simulator.

(b) Description of the Related Art

In general, simulators are in common use for providing graphics produced by a computer or images of the real world taken by a camera to a screen positioned in front of a user, and controlling the simulation to enable the user to perceive motion of the simulator as if they were experiencing the actual event. But a simulator cannot provide various simulator programs but only a limited number of programs for the user, because production of simulator software requires a complicated process.

Conventionally, the process of producing simulator software involves constructing a scenario and producing a ride film based on the scenario. Motion data for moving a simulator are generated through analysis of the scenario and are internally converted to control signals for controlling the actuator or the motion driver of the simulator. The control signals drive the actuator of the simulator to move so that the user feels motion synchronized with images. Production of simulator software greatly depends on whether the ride film contains graphics produced by a computer or images of the real world taken by a camera.

In regard to a simulator using computer graphics, production of a ride film involves a complicated procedure including scenario construction and modeling and hence requires a long production time, usually over several months. Contrarily, motion control signals for driving the actuator of the simulator are automatically generated by a computer during the process of scenario construction including modeling, thus requiring a relatively short time. So production of a ride film using images of the real world taken by a camera has been explored in order to reduce the required time for scenario construction or modeling, and to provide more realistic images for the user.

A simulator using images of the real world taken by a camera can provide visual sensations most approximate to the real world for the user. In this regard, the use of images directly taken by a camera mounted on an object such as a roller coaster, automobile, or aircraft enables production of a visually effective ride film in a short time. But three-dimensional motion data for driving the motor of the simulator are generated in a manual manner.

Production of data for driving the motor of the simulator is called motion base programming, which involves entering fundamental motions with a joystick with reference to images of the real world, retouching motion data using a waveform editor for each axis, and performing a test of the motion data in a real motion base. These procedures are repeated until satisfactory results are acquired. The use of images of the real world taken by a camera for a ride film requires too much time and cost in the course of the motion base programming.

### SUMMARY OF THE INVENTION

It is an object of the present invention to readily drive a simulator using images of the real world by making generation of motion data easier.

More specifically, the present invention is to simplify and automate a program-producing process from the step of constructing and designing a scenario for driving the simulator to the step of generating a simulator driving control program and to thereby produce a large number of simulator software programs in a short time.

In one aspect of the present invention, there is provided a simulator system including: a video recorder installed in a camera mounted on a vehicle to be simulated, for recording images and sounds; a motion sensor installed in the camera, for measuring motion data according to a pose change of the camera; a signal processor for generating control data to drive a simulator based on the motion data and the video/audio data output from the motion sensor and the video recorder; a simulator controller for generating simulation data to drive the simulator based on the control data output from the signal processor; and a motion interpreter for driving the simulator based on the simulation data.

The signal processor includes: a digital converter for converting video/audio signals output from the video recorder to digital video/audio data; a pose extractor for processing the motion data output from the motion sensor and generating motion effect data comprising position information and rotary motion information including acceleration and angular velocity for each axis x, y, and z; a motion unit separator for separating a motion unit from the motion data to generate a motion unit data stream and outputting the motion unit data stream together with the digital video/audio data; a motion unit determiner for recognizing and determining the motion unit and outputting the motion unit data and the digital video/audio data; and a control data generator for generating a control unit based on the motion unit and producing a control unit shift function and composite control data.

The signal processor further includes a simulation database for storing data output from the control data generator.

The motion unit represents position information and rotary motion information for fixed axes x, y, and z in a simulator assumed to have a complete degree of freedom in a movement space as acquired from the motion sensor. The control unit represents position information and rotary motion information according to the simulator having a fixed degree of freedom and a fixed movement space.

The motion sensor includes: a sensor comprising three accelerometers and three gyro sensors and generating acceleration information and angular velocity information for each axis x, y, and z; and a navigation processor for generating motion data including acceleration information and angular velocity information for each axis output from the sensor.

The simulator system may further include: an interface for a user s selecting a course and a motion level for driving the simulator. In this regard, the simulator controller generates simulator data based on the control data according to the course and motion level selected by the user.

In another aspect of the present invention, there is provided a method for producing a simulator program that includes: (a) generating video and audio information from a camera mounted on a vehicle to be simulated; (b) measuring motion data according to a pose change of the camera; (c) processing the motion data and generating motion effect data comprising position information and rotary motion information including acceleration and angular velocity for each axis x, y, and z; (d) separating a motion unit from the motion data to generate a motion unit data stream and synchronizing the motion unit data with video/audio data; (e) recognizing and determining a motion unit representing position information and rotary motion information for each axis x, y, and z based on the motion unit data stream; and (f) generating a control unit representing position information and rotary motion information suitable for a simulator having a fixed degree of freedom and a fixed movement space, based on the motion unit, and producing a control unit shift function and composite control data for controlling the simulator.

In addition, the method further includes: storing the composite control data; interpreting the stored composite control data, and generating simulator data for driving the simulator; and driving the simulator based on the simulator data.

The motion data measuring step includes: installing a motion sensor in the camera mounted on the vehicle to be simulated and measuring motion data based on a pose change of the camera from the motion sensor.

In a further aspect of the present invention, there is provided a simulator, which is driven under the control of a simulator system that includes a video recorder installed in a camera mounted on a vehicle to be simulated for recording images and sounds, a motion sensor installed in the camera for measuring motion data according to a pose change of the camera, a signal processor for generating control data to drive the simulator based on the motion data and the video/audio data output from the motion sensor and the video recorder, a simulator controller for generating simulation data to drive the simulator based on the control data output from the signal processor; and a motion interpreter for driving the simulator based on the simulation data, the simulator including: an interface for a user s selecting a course and a motion level for driving the simulator; a projector for projecting a corresponding image onto a screen based on video data output from the motion interpreter; a speaker for outputting audio data generated from the motion interpreter; and a motion driver for organically driving the user s seat for three translational (up-and-down, left-and-right, and backward-and-forward) motions and rotational motions around axes x, y, and z according to the simulation data output from the motion interpreter.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic of a simulator system in accordance with an embodiment of the present invention;

FIG. 2 is a schematic of the motion sensor shown in FIG. 1;

FIG. 3 is a block diagram showing the structure of a camera provided with the motion sensor of the present invention;

FIG. 4 is a perspective view showing the camera of FIG. 3 mounted on a vehicle;

FIG. 5 is a coordinate system used in the simulator in accordance with an embodiment of the present invention;

FIG. 6 is a schematic of the signal processor shown in FIG. 1;

FIG. 7 is a schematic of a simulator in accordance with an embodiment of the present invention;

FIG. 8 is a flow chart showing a simulation method in accordance with an embodiment of the present invention;

FIG. 9 is a step-based flow chart showing a simulation method in accordance with an embodiment of the present invention; and

FIGS. 10a, 10b, and 10c illustrate an example of the correlation among the simulator s velocity, acceleration, and actuator in accordance with an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

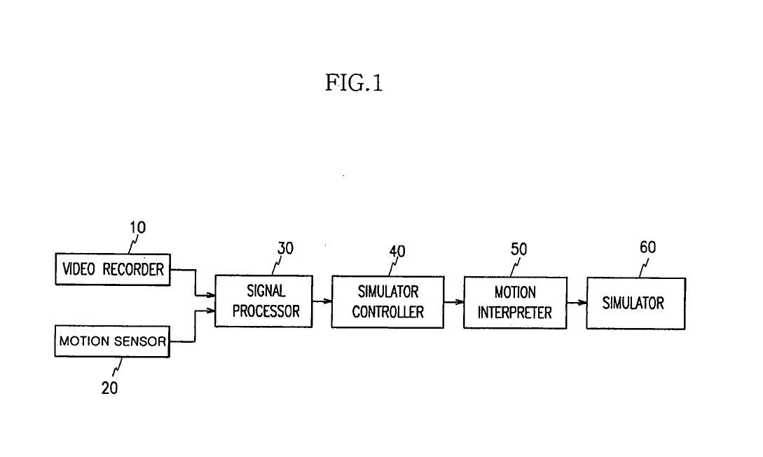

FIG. 1 is a block diagram of a simulator system according to the present invention. As shown in FIG. 1, the simulator system in accordance with an embodiment of the present invention comprises a video recorder 10, a motion sensor 20, a signal processor 30, a simulator controller 40, a motion interpreter 50, and a simulator 60.

The video recorder 10 and the motion sensor 20 are installed in a camera, which is mounted on a vehicle to be simulated. More specifically, the video recorder 10 stores images and sounds taken by the camera, and the motion sensor 20 measures motion data relating to a pose change of the camera.

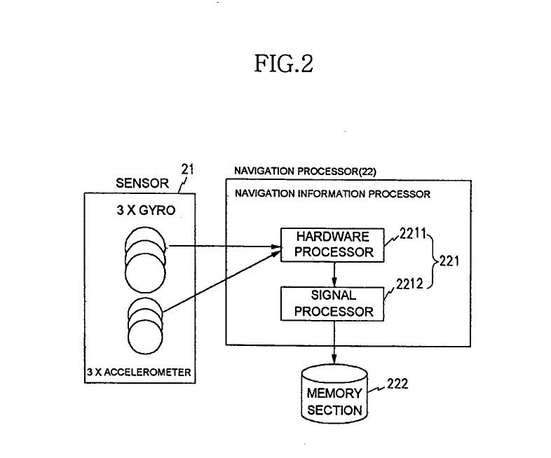

FIG. 2 is a detailed schematic of the motion sensor 20.

The motion sensor 20 comprises a sensor 21 including three accelerometers and three gyro sensors, and a navigation processor 22 for generating motion data based on the data output from the sensor 21. The navigation processor 22 comprises a navigation information processor 221 including a hardware processor 2211 and a signal processor 2212, and a memory section 222.

The hardware processor 2211 in the navigation information processor 221 performs initialization of hardware, processing of input/output of the hardware and self-diagnosis, and stably receives information from the sensor 21. The signal processor 2212 outputs motion data including acceleration and angular velocity for each axis. The motion data are stored in the memory section 222.

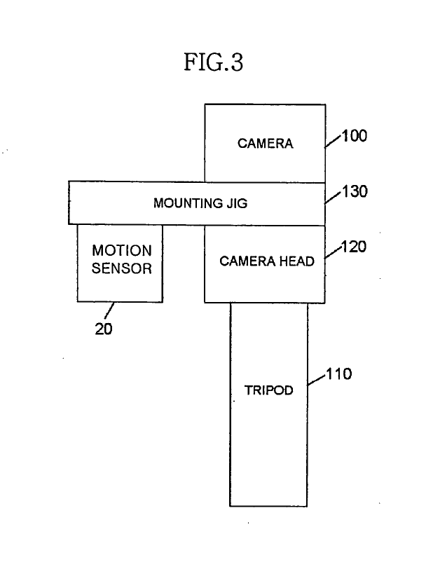

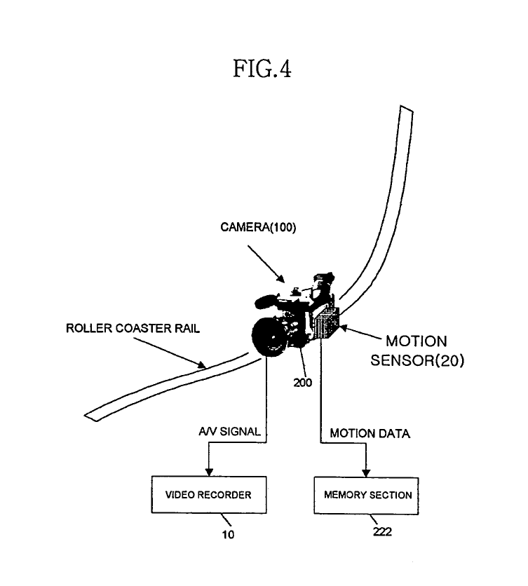

FIG. 3 is a block diagram showing the motion sensor 20 installed in a camera 100, and FIG. 4 is a perspective view showing the camera 100 mounted on a vehicle.

Referring to FIG. 3, a camera head 120 is disposed on the top of a tripod 110 used as a support for the camera 100, and a motion sensor-mounting jig 130 is positioned on the camera head 120. The camera 100 is fixed on the motion sensor-mounting jig 130 and the motion sensor 20 is installed underneath the motion sensor-mounting jig 130.

Referring to FIG. 4, the camera 100 with the motion sensor 20 is mounted firmly on a vehicle 200 to be simulated, such as a roller coaster or a Viking ship ride. The mounting position of the camera 100 has coordinates nearest to the passenger s view position, and the sensor 21 generates information about acceleration and angular velocity based on a preset coordinate system.

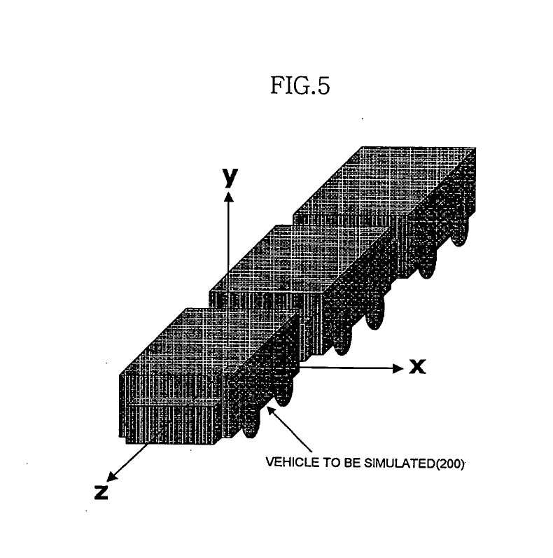

FIG. 5 shows a preset coordinate system in accordance with an embodiment of the present invention. In FIG. 5, the vehicle 200 to be simulated is moving in the positive direction of the Z-axis, the positive direction of the X-axis points to its left, and the positive direction of the Y-axis points upwards.

As the vehicle is driven to move, video/audio signals according to the motion are stored in the video recorder 10 and the motion data (acceleration and angular velocity for each axis as defined in FIG. 5) generated from the motion sensor 20 are stored in the memory section 222. The time codes of images are also stored in the memory section 222 at the same time.

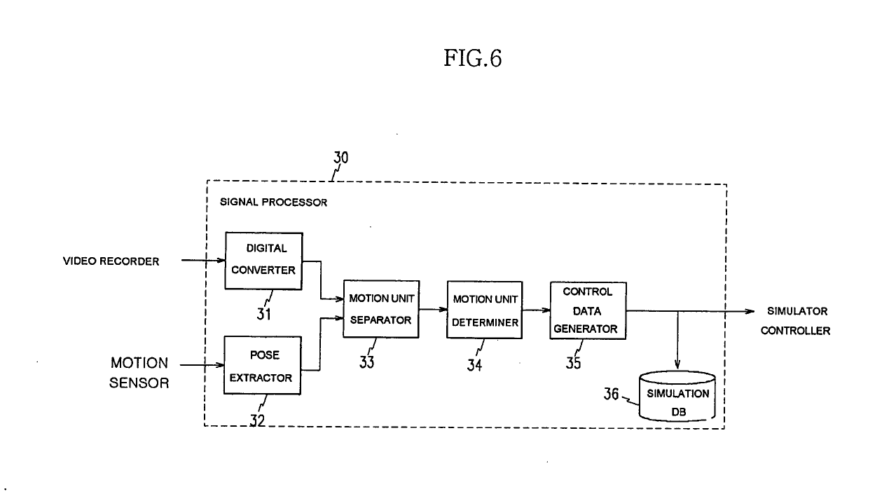

FIG. 6 shows a schematic of the signal processor 30 that generates control data for driving the simulator based on the data output from the motion sensor 20 and the video recorder 10.

The signal processor 30 comprises, as shown in FIG. 6, a digital converter 31, a pose extractor 32, a motion unit separator 33, a motion unit determiner 34, a control data generator 35, and a simulation database 36.

The digital converter 31 converts the video/audio signals output from the video recorder 10 to digital signals. The pose extractor 32 processes the motion data output from the motion sensor 20 and generates motion effect data including position information and rotary motion information including acceleration and angular velocity for each axis.

The motion unit separator 33 separates a motion unit to generate a motion unit data stream and to output digital video/audio data to the motion unit determiner 34. The motion unit determiner 34 recognizes and determines the motion unit and outputs the determined motion unit data and the digital video/audio data to the control data generator 35.

The motion unit comprises pose information computed assuming that the simulator has a complete degree of freedom for every axis. Namely, the motion unit includes position information and rotary motion information computed for three fixed axes in the simulator, assuming it has a complete degree of freedom of movement, acquired from the sensor 21 of the motion sensor 20.

The control data generator 35 generates a control unit based on the motion unit and a control unit shift function, and compresses composite control data. The control unit includes position information and rotary motion information optimally computed for a specialized simulator that has a fixed degree of freedom and a fixed movement space. These data are stored in the simulation database 36.

The simulator controller 40 generates simulator data based on the control data stored in the simulation database 36 of the signal processor 30. The motion interpreter 50 drives the simulator 60 based on the simulation data.

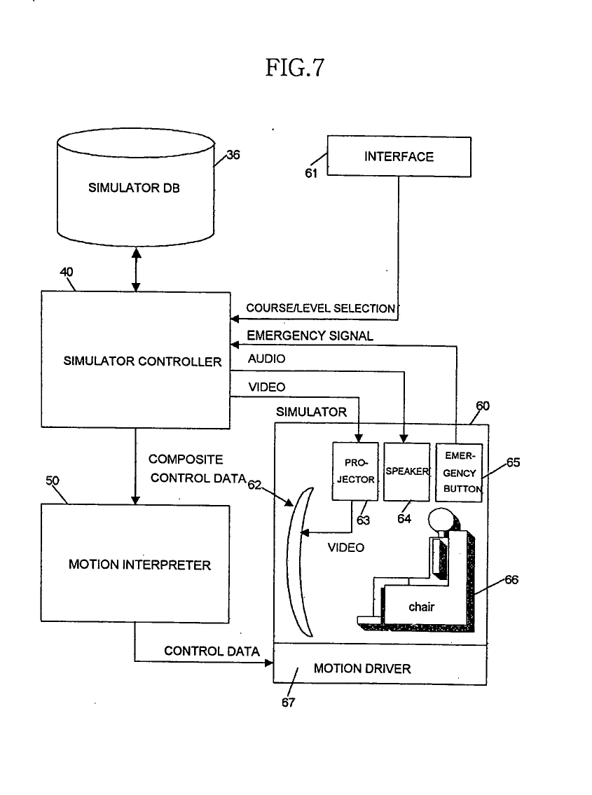

FIG. 7 shows a schematic of the simulator 60 in accordance with an embodiment of the present invention.

The augmented reality heuristic simulator 60 usable in the embodiment of the present invention is a simulator for one or two persons, and it is designed to organically simulate a 6-degrees-of-freedom motion, i.e., three (up-and-down, left-and-right, and backward-and-forward) translational motions and three rotational motions around each axis so that the user(s) can feel dynamic motion of the simulator as if they were experiencing the actual event. The simulator 60 comprises an interface 61 controlled by an operator, a screen 62, a projector 63 for projecting images onto the screen 62, a speaker 64 for generating sounds, an emergency button 65 for stopping the simulator in an emergency, a seat 66, and a motion driver 67 comprising an actuator or a motor.

Now, a detailed description will be given to a method for producing a simulator program and a simulation method in accordance with an embodiment of the present invention based on the above configuration.

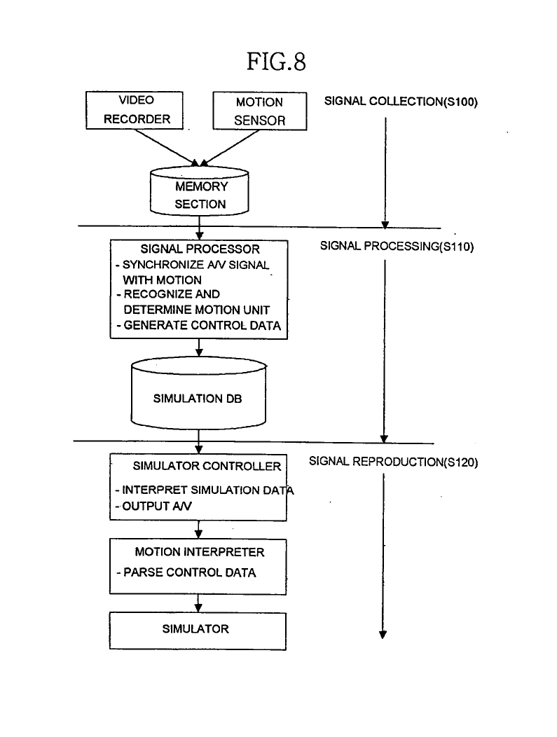

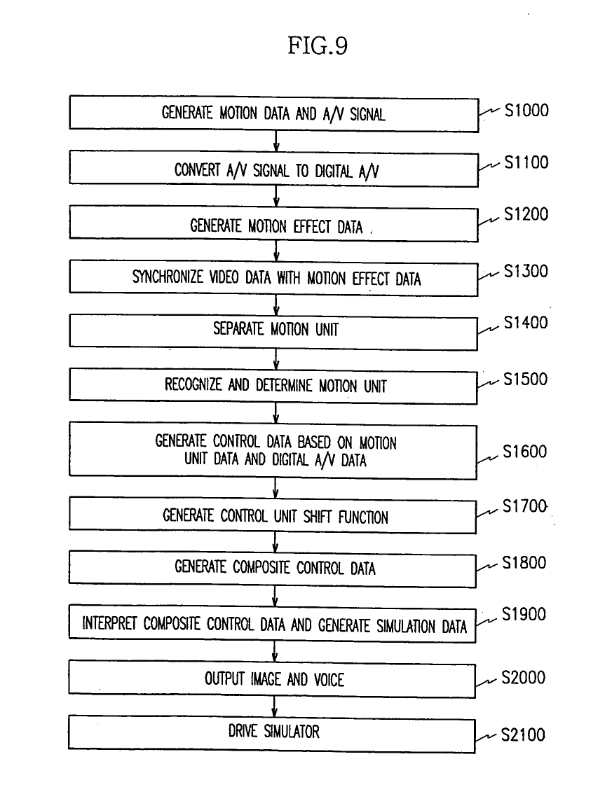

FIG. 8 is a flow chart showing the simulation method according to an embodiment of the present invention, and FIG. 9 shows a step-based process of the simulation method.

The simulation method in the embodiment of the present invention comprises signal collection (step 100), signal processing (step 110), and signal reproduction (step 120).

The signal collecting step (step 100) includes causing the user to select a vehicle to be simulated, mounting a camera with the video recorder 10 and the motion sensor 20 on the vehicle, taking a test ride of the vehicle, and generating video/audio information and motion data relating to a pose change of the camera and storing them in the memory section 222.

The signal processing step (step 110) includes the signal processor 30 synchronizing the video/audio information with the motion data, recognizing motion units, generating a control unit and a control unit shift function, and storing compressed composite control data in the simulation database 36.

The signal reproducing step (step 120) includes the simulator controller 40 receiving the control data and the digital video/audio data from the simulation database 36 and interpreting the simulation data to generate composite control data, and the motion interpreter 50 parsing and interpreting the composite control data to output control data and driving the motion driver 67 of the simulator 60 to provide dynamic motion.

Now, the respective steps will be described in detail.

First, the user selects a vehicle to be simulated, mounts a camera with the video recorder 10 and the motion sensor 20 on the vehicle, and takes a test ride of the vehicle to generate video/audio information and motion data relating to a pose change of the camera.

The video/audio signals output from the video recorder 10 are converted to digital data through the digital converter 31 of the signal processor 30 and fed into the motion unit separator 33. The motion data output from the motion sensor 20 are converted to motion effect data comprising position information and rotary motion information including acceleration and angular velocity for each axis through the pose extractor 32 of the signal processor 30, which executes a position/velocity computing algorithm and a pose computing algorithm. The motion data are synchronized with the digital video/audio data and fed into the motion unit separator 33.

The motion unit separator 33 of the signal processor 30 separates the motion unit from the motion data and outputs the motion unit data stream and the digital video/audio data to the motion unit determiner 34. The motion unit determiner 34 recognizes and determines the motion unit and outputs the motion unit data and the digital video/audio data to the control data generator 35. A washout algorithm is used in generation of the motion unit according to the embodiment of the present invention.

The control data generator 35 generates an optimized control value including position information and rotary motion information to a specialized simulator having a fixed degree of freedom and a fixed movement space, based on the motion unit, produces a control unit shift function, and compresses composite control data. The data thus generated are stored in the simulation database 36.

The acceleration and angular velocity obtained from the motion sensor 20 are subjected to the above-stated signal processing procedure because the simulator 60 has limitations in movement area and motion, while the vehicle 30 to be simulated, such as a roller coaster, is allowed three-dimensional unlimited motion. If the simulator 60 can make three-dimensional unlimited motion, the motion unit separator 33, the motion unit determiner 34 and the control data generator 35 of the signal processor 30 will become unnecessary. Hence, the washout algorithm is used in the present invention.

A human s sensing of motion basically relies on visual sensation and static sense for translational and rotational motions. It is of importance in this regard to recognize that a change of momentary acceleration rather than continuous acceleration has a great effect on the human s sensing of motion. This is particularly more effective in relation to visual factors. Based on this principle, temporary acceleration is imposed and is then gradually reduced to produce a motion effect, which is technically called washout. This technology can be effectively applied when a motion effect has to be produced in a simulator that is allowed only a limited motion in a limited space.

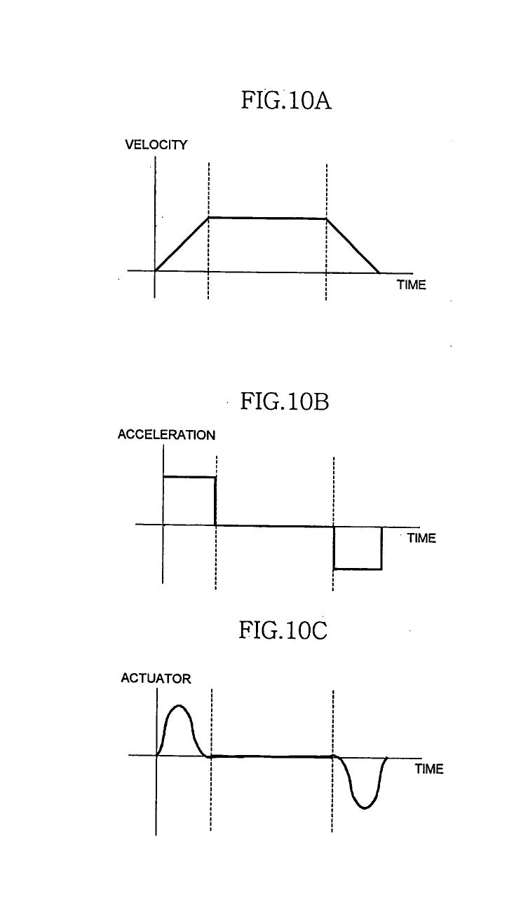

FIGS. 10a, 10b, and 10c show the correlation among velocity, acceleration, and actuation of the simulator 60 using the washout algorithm. If the velocity changes as shown in FIG. 10a, the acceleration is varied as in FIG. 10b. In the present invention, the sensor 21 of the motion sensor 20 accurately acquires the results of FIG. 10b in an automatic manner. When the acceleration of FIG. 10b is directly applied to the simulator 60, a desired effect cannot be expected due to spatial and kinetic limitations. So the washout algorithm is used to acquire the results of FIG. 10c in order to provide a desired motion effect for the user.

The present invention can extract information for controlling simulators of different standards from one motion data set by independently processing motion data, a motion unit, and a control unit. The motion data are the most fundamental information acquired from the vehicle 200 to be simulated and produced for a three-dimensional unlimited space. The motion unit is the result acquired using the washout algorithm on the assumption that the simulator has limitation only in translational motion other than rotational motion around axes in a limited space.

The control data generator 35 receives the motion unit and the information about the degree of freedom and the movement space for the simulator 60, and generates the control unit based on the motion unit and the information. This restricts the motion unit acquired using the washout algorithm again, and acquires the results for the simulator that will actually be used.

As stated above, the motion data and the video/audio data generated from the motion sensor 20 and the video recorder 10, respectively, are processed to generate composite control data, which are stored and used to drive the simulator.

First, the simulator controller 40 provides a user interface for the user s selecting a course and a level through the interface 61 and reads out the control data, the control unit shift function, and the digital video/audio data from the simulation database 36 according to the selected option. This information is interpreted to output the audio data to the speaker 64 of the simulator 60 and to project the video data onto the screen 62 via the projector 63 of the simulator 60. The simulator controller 40 interprets the control data and the control unit shift function and outputs driver composite control data to the motion interpreter 50. Here, the control data are position information in the user s simulator.

The simulator controller 40 controls the special effects and the motion and images/sounds of the motion driver 67 comprising the actuator or motor of the simulator 60 to be generated in synchronization with one another.

The motion interpreter 50 performs control data parsing, translational motion (up-and-down, left-and-right, and backward-and-forward), rotational motion (roll, pitch, and yaw), and composite motion, converts the composite control data to control data, and outputs the control data to the motion driver 67 of the simulator for dynamic motion of the simulator 60. Namely, the user s position information is converted to motion for each motion driver 67 constituting the simulator 60.

Accordingly, programs can be produced simply by mounting the video camera 100 with the motion sensor 20 on the vehicle 200 to be simulated and recording motion and images of the vehicle 200, thereby making it possible to provide a large number of programs in a short time.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

According to the above-described embodiment of the present invention, a program-producing process from the step of constructing and designing a scenario for driving a simulator to the step of generating a motor driver control program can be simplified and automated to produce a large number of simulator driving programs in a short time.

The augmented reality heuristic simulator of the present invention provides images giving a realistic feeling of riding a vehicle to the user rather than using computer graphic images, and it creates a more realistic simulation environment.

Furthermore, the present invention readily provides different programs for one simulator so that the user can use the simulator to enjoy a large-sized entertainment facility such as a roller coaster in a relatively small space.

What is claimed is:

1. A simulator system comprising:
a video recorder installed in a camera mounted on a vehicle to be simulated, for recording images and sounds;
a motion sensor installed in the camera, for measuring motion data according to a pose change of the camera;
a signal processor for generating control data to drive a simulator based on the motion data and the video/audio data output from the motion sensor and the video recorder;
a simulator controller for generating simulation data to drive the simulator based on the control data output from the signal processor; and
a motion interpreter for driving the simulator based on the simulation data.

2. The simulator system as claimed in claim 1, wherein the signal processor comprises:
a digital converter for converting video/audio signals output from the video recorder to digital video/audio data;
a pose extractor for processing the motion data output from the motion sensor and generating motion effect data comprising position information and rotary motion information including acceleration and angular velocity for each axis x, y, and z;
a motion unit separator for separating a motion unit from the motion data to generate a motion unit data stream and outputting the motion unit data stream together with the digital video/audio data;
a motion unit determiner for recognizing and determining the motion unit and outputting the motion unit data and the digital video/audio data; and
a control data generator for generating a control unit based on the motion unit and producing a control unit shift function and composite control data.

3. The simulator system as claimed in claim 2, wherein the signal processor further comprises a simulation database for storing data output from the control data generator.

4. The simulator system as claimed in claim 2, wherein the motion unit represents position information and rotary motion information for fixed axes x, y, and z in a simulator assumed to have a complete degree of freedom in a movement space as acquired from the motion sensor,
the control unit representing position information and rotary motion information according to the simulator having a fixed degree of freedom and a fixed movement space.

5. The simulator system as claimed in claim 1, wherein the motion sensor comprises:
a sensor comprising three accelerometers and three gyro sensors and generating acceleration information and angular velocity information for each axis x, y, and z; and
a navigation processor for generating motion data including acceleration information and angular velocity information for each axis output from the sensor.

6. The simulator system as claimed in claim 1, further comprising:
an interface for a user s selecting a course and a motion level for driving the simulator,
the simulator controller generating simulator data based on the control data according to the course and motion level selected by the user.

7. A method for producing a simulator program, comprising:
(a) generating video and audio information from a camera mounted on a vehicle to be simulated;
(b) measuring motion data according to a pose change of the camera;
(c) processing the motion data and generating motion effect data comprising position information and rotary motion information including acceleration and angular velocity for each axis x, y, and z;
(d) separating a motion unit from the motion data to generate a motion unit data stream and synchronizing the motion unit data with video/audio data;
(e) recognizing and determining a motion unit representing position information and rotary motion information for each axis x, y, and z based on the motion unit data stream; and
(f) generating a control unit representing position information and rotary motion information suitable for a simulator having a fixed degree of freedom and a fixed movement space, based on the motion unit, and producing a control unit shift function and composite control data for controlling the simulator.

8. The method as claimed in claim 7, further comprising:
storing the composite control data;
interpreting the stored composite control data and generating simulator data for driving the simulator; and
driving the simulator based on the simulator data.

9. The method as claimed in claim 7, wherein the motion data measuring step comprises installing a motion sensor in the camera mounted on the vehicle to be simulated and measuring motion data based on a pose change of the camera from the motion sensor.

10. A simulator, which is driven under the control of a simulator system that includes a video recorder installed in a camera mounted on a vehicle to be simulated for recording images and sounds, a motion sensor installed in the camera for measuring motion data according to a pose change of the camera, a signal processor for generating control data to drive the simulator based on the motion data and the video/audio data output from the motion sensor and the video recorder, a simulator controller for generating simulation data to drive the simulator based on the control data output from the signal processor; and a motion interpreter for driving the simulator based on the simulation data, the simulator comprising:
an interface for a user s selecting a course and a motion level for driving the simulator;
a projector for projecting a corresponding image onto a screen based on video data output from the motion interpreter;
a speaker for outputting audio data generated from the motion interpreter; and
a motion driver for organically driving the user s seat for three translational (up-and-down, left-and-right, and backward-and-forward) motions and rotational motions around axes x, y, and z according to the simulation data output from the motion interpreter.
